(19) United States
(12) Patent Application Publication
(10) Pub. No.: US 2012/0174819 A1
(43) Pub. Date: Jul. 12, 2012

(54) Wet Cell Arrangement for Rail Vehicles

(76) Inventor: Sander Van Lieshout, Tonisvorst (DE)

(21) Appl. No.: 12/985,398

(22) Filed: Jan. 6, 2011

(51) Int. Cl. B61D 35/00; B60N 3/00; B61D 1/00; B61D 17/00

(52) U.S. Cl. 105/329.1

(57) ABSTRACT

A wet cell arrangement for a carriage body of a rail vehicle is provided. The carriage body includes two wet cells which are bounded in each case on one side by a functional wall. The functional walls are arranged in a manner spaced apart from and facing one another. Jointly useable supply and disposal lines are arranged in an intermediate space between the two functional walls of the two wet cells.

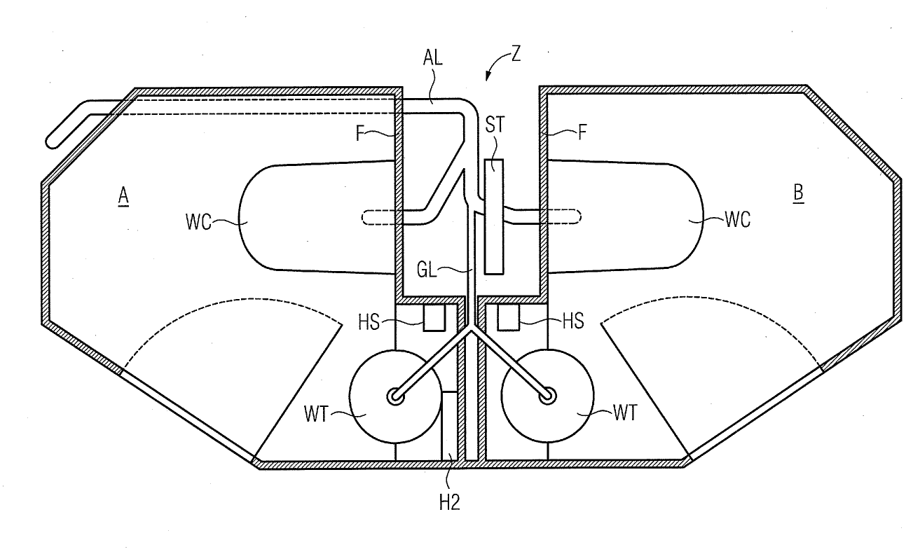

### FIELD OF INVENTION

The invention relates to a wet cell arrangement for a carriage body of a rail vehicle, having at least two wet cells arranged in the carriage body.

### BACKGROUND OF INVENTION

It is known in the field of rail vehicles to provide individual carriage bodies with a plurality of wet cells, typically two. In a first, known embodiment, the wet cells are in the form of individual cabins, which are arranged opposite one another in the carriage body. Furthermore, there is what is known as a “twin combination” of two wet cells, which is characterized in that two wet cells are arranged in succession. In this known embodiment, too, the character of the wet cell remains that of autonomous individual cabins.

It is generally regarded as disadvantageous in the construction of rail vehicles that any supply devices, such as wastewater piping for wet cells, for example, have to be provided in large numbers.

### SUMMARY OF INVENTION

An object of the invention is to provide a wet cell arrangement, in which the expenditure on supply and disposal devices for the wet cells is reduced.

In the case of the wet cell arrangement mentioned at the beginning, this object is achieved in that the at least two wet cells are bounded in each case on one side by a functional wall, the functional walls are arranged in a manner spaced apart from and facing one another, and jointly useable supply means are arranged in an intermediate space between the two functional walls of the at least two wet cells.

What is achieved thereby is that joint supply means can be used for particular components of the wet cells, and so, compared with the prior art, in which individual cabins are provided, a considerable potential saving can be obtained.

By way of example, the two functional walls may have gray-water connections, wherein associated gray-water piping is arranged in the intermediate space.

In a further embodiment, the two functional walls may each have wastewater connections, wherein wastewater piping is in turn arranged in the intermediate space. It is possible, both for the gray-water piping and for the wastewater piping, to combine the drainpipes coming from the at least two wet cells into a joint wastewater line, which opens into a wastewater tank.

It is furthermore conceivable to provide the two functional walls in such a way that they each have fan connections and a fan heater is arranged in the intermediate space and is connected to the fan connections. What is achieved thereby is that a single fan heater can be employed for air-conditioning the two wet cells. Said fan heater can optionally have a greater capacity compared with the prior art.

It can also be provided that a joint control panel is arranged in the intermediate space in order to control toilets in the at least two wet cells. Compared with the prior art, the control panel, which is arranged there within the individual cabin, is placed in the intermediate space, it being possible at the same time for a single control panel to be used for controlling the toilets in the two wet cells.

The two functional walls may each have a towel dispenser, which is arranged at least partially in the intermediate space. This means that the towel dispenser does not have to be accommodated fully in the associated wet cell. Instead, it is possible to use part of the intermediate space to hold optionally the entire towel dispenser, too, thereby saving space within the wet cell.

For a favorable configuration of the piping, but also an arrangement of the fan heater or of the towel dispenser, it may be favorable for the at least two wet cells to be formed in a mirror-symmetrical manner in relation to a vertical center plane of the intermediate space. In such cases, respective connections are opposite one another, thus allowing them to be combined in a simple manner to form a joint main line.

With regard to the use of the functional walls in the at least two wet cells, it should be noted that it is possible for them to be preassembled and tested in a fully equipped state.

### BRIEF DESCRIPTION OF THE DRAWINGS

An exemplary embodiment of the invention is explained in more detail below with reference to the drawing. The single drawing shows a schematic top view of a wet cell arrangement.

### DETAILED DESCRIPTION OF INVENTION

The wet cell arrangement shown in the figure has two wet cells A, B, wherein walls which face one another of the wet cells A, B are formed as functional walls F. The functional walls F are located opposite one another and are spaced apart from one another such that an intermediate space Z is produced, said intermediate space Z serving to accommodate jointly used functional elements.

The wet cells A, B are formed in a mirror-symmetrical manner in relation to a vertical center plane of the intermediate space Z and have a toilet WC, a washbasin WT with an associated faucet, soap dispenser and towel dispenser HS.

Gray-water piping is connected by way of two branches to the washbasins WT. The two branches combine to form a common main gray-water line GL, which leads to the wastewater tank. The two toilets WC are connected to respective wastewater piping branches, said wastewater piping opening into a main wastewater line AL, which leads to a wastewater tank.

The towel dispensers HS provided in each case are arranged within the intermediate space Z. Above the washbasin WT there is a mirror cabinet, from which access is possible. Each wet cell A, B is drawn inward in the region of the washbasins WT.

A fan heater H2 is furthermore arranged in the intermediate space Z and is connected to air-conditioning connections (not shown here) of the functional walls F, and so a single heater, namely the fan heater H2, can be used to air-condition both wet cells A, B.

A joint control panel ST for the two toilets WC is likewise arranged in the intermediate space Z and serves to control the toilets WC in the two wet cells A, B.

1. A wet cell arrangement for a carriage body of a rail vehicle, comprising:
two wet cells arranged in the carriage body; and
two functional walls,
wherein the two wet cells are bounded in each case on one side by one functional wall, the two functional walls being arranged in a manner spaced apart from and facing one another, and
wherein jointly useable supply and disposal lines are arranged in an intermediate space between the two functional walls.

2. The arrangement as claimed in claim 1,
wherein the two functional walls have gray-water connections and associated gray-water piping is arranged in the intermediate space.

3. The arrangement as claimed in claim 1,
wherein the two functional walls each have wastewater connections and wastewater piping is arranged in the intermediate space.

4. The arrangement as claimed in claim 2,
wherein the two functional walls each have wastewater connections and wastewater piping is arranged in the intermediate space.

5. The arrangement as claimed in claim 1,
wherein the two functional walls each have fan connections and a fan heater is arranged in the intermediate space and is connected to the fan connections.

6. The arrangement as claimed in claim 4,
wherein the two functional walls each have fan connections and a fan heater is arranged in the intermediate space and is connected to the fan connections.

7. The arrangement as claimed in claim 1,
wherein a joint control panel is arranged in the intermediate space in order to control toilets in the two wet cells.

8. The arrangement as claimed in claim 6,
wherein a joint control panel is arranged in the intermediate space in order to control toilets in the two wet cells.

9. The arrangement as claimed in claim 1,
wherein the two functional walls each have a towel dispenser which are arranged at least partially in the intermediate space.

10. The arrangement as claimed in claim 8,
wherein the two functional walls each have a towel dispenser which are arranged at east partially in the intermediate space.

11. The arrangement as claimed in claim 1,
wherein the two wet cells are formed in a mirror-symmetrical manner in relation to a center plane of the intermediate space.

12. The arrangement as claimed in claim 10,
wherein the two wet cells are formed in a mirror-symmetrical manner in relation to a center plane of the intermediate space.
